(19) United States
(12) Patent Application Publication
(10) Pub. No.: US 2004/0100880 A1
(43) Pub. Date: May 27, 2004

(54) Disk apparatus and disk processing method

(75) Inventor: Takahiro Suzuki, Fuchu-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/713,119

(22) Filed: Nov. 17, 2003

(30) Foreign Application Priority Data
Nov. 21, 2002 (JP) 2002-338038

(51) Int. Cl. G11B 7/00

(52) U.S. Cl. 369/47.14; 369/53.17

(57) ABSTRACT

A disk apparatus of this invention includes a defect detection unit configured to detect a defect of a disk, a setting unit configured to set an actual recording area, where information can actually be recorded, of all recording areas of the disk on the basis of the defect detection result by the defect detection unit, and a recording unit configured to record user information in the actual recording area set by the setting unit.

### CROSS-REFERENCE TO RELATED APPLICATIONS

This application is based upon and claims the benefit of priority from the prior Japanese Patent Application No. 2002-338038, filed Nov. 21, 2002, the entire contents of which are incorporated herein by reference.

### BACKGROUND OF THE INVENTION

1. Field of the Invention

The present invention relates to a disk apparatus which records information on a disk such as a CD-R, CD-RW, DVD-R, or DVD-RW. The present invention also relates to a disk processing method of processing the disk.

2. Description of the Related Art

In recent years, optical disks such as a CD-R, CD-RW, DVD-R, and DVD-RW have become available. Accordingly, optical disk drives that record information on these optical disks or reproduce information from these optical disks have also become available.

Upon receiving an optical disk, an optical disk drive inspects the logical and physical specifications of the received optical disk, thereby executing normal reproduction/recording operation for the optical disk.

The optical disk drive sometimes inspects even various kinds of defects of an optical disk as well as its logical and physical specifications. Jpn. Pat. Appln. KOKAI Publication No. 10-312568 discloses a technique for causing an optical disk drive to obtain an optimum recording power value in accordance with a defect inspection result.

According to the above technique, however, since information is recorded even in areas having defects, the reliability of the optical disk decreases. In addition, the optical disk may wholly become unusable due to some serious defects.

### BRIEF SUMMARY OF THE INVENTION

A disk apparatus according to an aspect of the present invention comprises a defect detection unit configured to detect a defect of a disk, a setting unit configured to set an actual recording area, where information can actually be recorded, of all recording areas of the disk on the basis of a defect detection result by the defect detection unit, and a recording unit configured to record user information in the actual recording area set by the setting unit.

A disk processing method according to an aspect of the present invention comprises detecting a defect of a disk, and on the basis of a defect detection result, setting an actual recording area, where information can actually be recorded, of all recording areas of the disk.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the schematic arrangement of an optical disk apparatus according to an embodiment of the present invention;

FIG. 2 is a flow chart showing an example of an optical disk handling method; and

FIG. 3 is a view showing an optical disk according to an embodiment of the present invention.

### DETAILED DESCRIPTION OF THE INVENTION

An embodiment of the present invention will be described below with reference to the accompanying drawing.

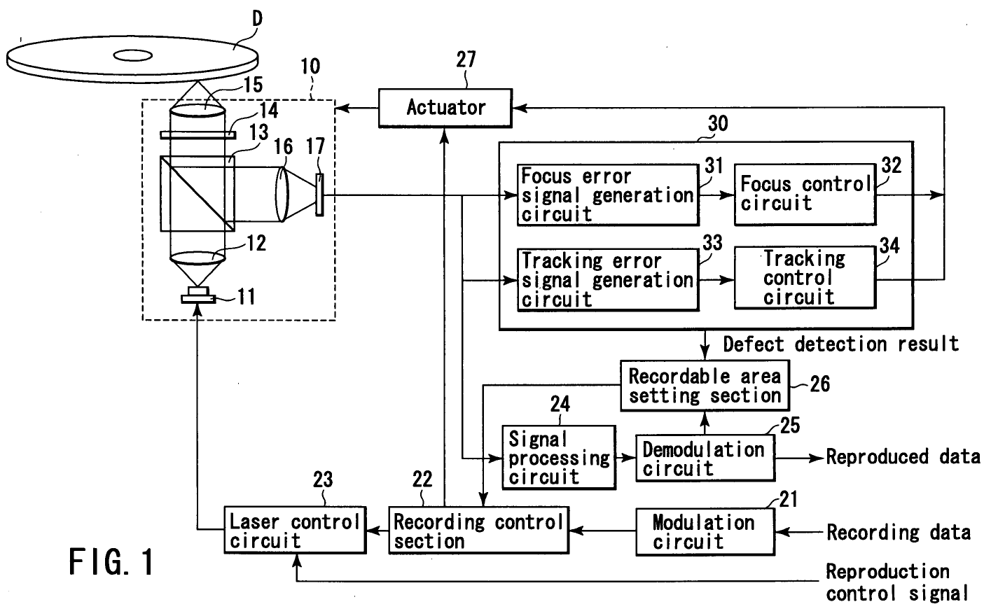

FIG. 1 is a view showing the schematic arrangement of an optical disk apparatus according to an embodiment of the present invention This optical disk apparatus records information on an optical disk D such as a CD-R, CD-RW, DVD-R, or DVD-RW or reproduces information recorded on the optical disk D.

As shown in FIG. 1, the optical disk apparatus comprises an optical pickup 10, modulation circuit 21, recording control section 22, laser control circuit 23, signal processing circuit 24, demodulation circuit 25, recordable area setting section 26, actuator 27, and defect detection section 30.

The optical pickup 10 comprises a laser 11, collimator lens 12, polarizing beam splitter (to be referred to as a PBS hereinafter) 13, λ/4 plate 14, objective lens 15, condenser lens 16, and photodetector 17.

The defect detection section 30 comprises a focus error signal generation circuit 31, focus control circuit 32, tracking error signal generation circuit 33, and tracking control circuit 34.

Information recording on the optical disk D by the optical disk apparatus will be described first. The modulation circuit 21 modulates recording information (data symbol) into a channel bit sequence in accordance with a predetermined modulation scheme. The channel bit sequence corresponding to the recording information is input to the recording control section 22. The recording control section 22 outputs a control signal to the actuator 27 and makes it to drive the optical pickup to appropriately focus a light beam to a target recording position. The recording control section 22 also supplies the channel bit sequence to the laser control circuit 23. The laser control circuit 23 converts the channel bit sequence into a laser drive waveform and drives the laser 11. That is, the laser control circuit 23 pulse-drives the laser 11. Accordingly, the laser 11 emits a recording light beam corresponding to the desired bit sequence. The recording light beam emitted from the laser 11 is collimated into a parallel beam by the collimator lens 12 and becomes incident on and passes through the PBS 13. The beam that has passed through the PBS 13 passes through the λ/4 plate 14 and is focused on the information recording surface of the optical disk D through the objective lens 15. Under the focus control by the focus control circuit 32 and actuator 27 and the tracking control by the tracking control circuit 34 and actuator 27, the focused recording light beam is maintained in a state wherein a best small spot can be obtained on the recording surface.

Data reproduction from the optical disk D by this optical disk apparatus will be described subsequently. The laser control circuit 23 drives the laser 11 on the basis of a reproduction control signal. Accordingly, the laser 11 emits a reproduction light beam. The reproduction light beam emitted from the laser 11 is collimated into a parallel beam by the collimator lens 12 and becomes incident on and passes through the PBS 13. The light beam that has passed through the PBS 13 passes through the λ/4 plate 14 and is focused on the information recording surface of the optical disk D through the objective lens 15. Under the focus control by the focus control circuit 32 and actuator 27 and the tracking control by the tracking control circuit 34 and actuator 27, the focused reproduction light beam is maintained in a state wherein a best small spot can be obtained on the recording surface. At this time, the reproduction light beam that irradiates the optical disk D is reflected by a reflecting film or reflective recording film in the information recording surface. The reflected light passes through the objective lens 15 in the reverse direction and is converted into a parallel light beam again. The reflected light passes through the λ/4 plate 14. The light has a polarization perpendicular to the incident light and is reflected by the PBS 13. The beam reflected by the PBS 13 is converged by the condenser lens 16 and becomes incident on the photodetector 17. The photodetector 17 is formed from, e.g., a four-split photodetector. The light beam incident on the photodetector 17 is photoelectrically converted into an electrical signal and amplified. The amplified signal is equalized and binarized by the signal processing circuit 24 and sent to the demodulation circuit 25. The demodulation circuit 25 executes a demodulation operation corresponding to the predetermined modulation scheme so that reproduced data is output.

On the basis of part of the electrical signal output from the photodetector 17, the focus error signal generation circuit 31 generates a focus error signal. Similarly, on the basis of part of the electrical signal output from the photodetector 17, the tracking error signal generation circuit 33 generates a tracking error signal. The focus control circuit 32 controls the actuator 27 on the basis of the focus error signal to control focus of the beam spot. The tracking control circuit 34 controls the actuator 27 on the basis of the tracking error signal to control tracking of the beam spot.

The defect detection section 30 detects defects of the optical disk by monitoring, e.g., the focus error signal and tracking error signal. To detect defects of the optical disk, various factors except the focus error signal and tracking error signal can be used. Defects of the optical disk degrade the recording/reproduction performance of the optical disk. Examples of defects to be detected by the defect detection section 30 are as follows.

Warping of the disk

Eccentricity of the barycenter of the disk

Eccentricity of the center of the disk

Waviness of the disk

On the basis of the defect detection result, the recordable area setting section 26 sets recordable areas (=actual recording areas), where information can actually be recorded, of all the recording areas of the optical disk D. Information about the recordable areas set by the recordable area setting section 26 is sent to the recording control section 22. The recording control section 22 controls the actuator 27 to record user information in the recordable areas.

Defect inspection of the optical disk and the recording performance of the optical disk will be described next. When the optical disk D is inserted into the optical disk apparatus shown in FIG. 1, the optical disk apparatus inspects defects that should degrade the recording performance of the inserted optical disk D. That is, as described above, the defect detection section 30 detects defects of the optical disk by, e.g., monitoring the focus error signal and tracking error signal.

Let n be the number of defect elements to be inspected, and D₁, D₂, . . . , Dₙ be the defect elements. The inserted optical disk D is divided into m (m is a natural number) areas 1, 2, . . . , m. Let Dᵢⱼ be a value corresponding to an area j of a defect element Dᵢ. More specifically, when the defect element Dᵢ can be inspected in each area, the value of the defect element Dᵢ inspected in the area j is defined as Dᵢⱼ. When the defect element Dᵢ is constantly present independently of the area, Dᵢ₁=Dᵢ₂=, . . . , =Dᵢₘ. When defects that should degrade the recording performance of the inserted optical disk D are inspected, the followings are obtained.

Set {D₁₁, D₂₁, . . . , Dₙ₁} of inspection values of defect elements in area 1

Set {D₁₂, D₂₂, . . . , Dₙ₂} of inspection values of defect elements in area 2

Set {D₁ⱼ, D₂ⱼ, . . . , Dₙⱼ} of inspection values of defect elements in area j

Set {D₁ₘ, D₂ₘ, . . . , Dₙₘ} of inspection values of defect elements in area m

Recording performance Aⱼ predicted in the area j is obtained from the set {D₁ⱼ, D₂ⱼ, . . . , Dₙⱼ} of inspection values of defect elements in area j.

Aⱼ=f(D₁ⱼ, D₂ⱼ, . . . , Dₙⱼ)

The recordable area setting section 26 executes recordability determination of each area using the recording performance Aⱼ.

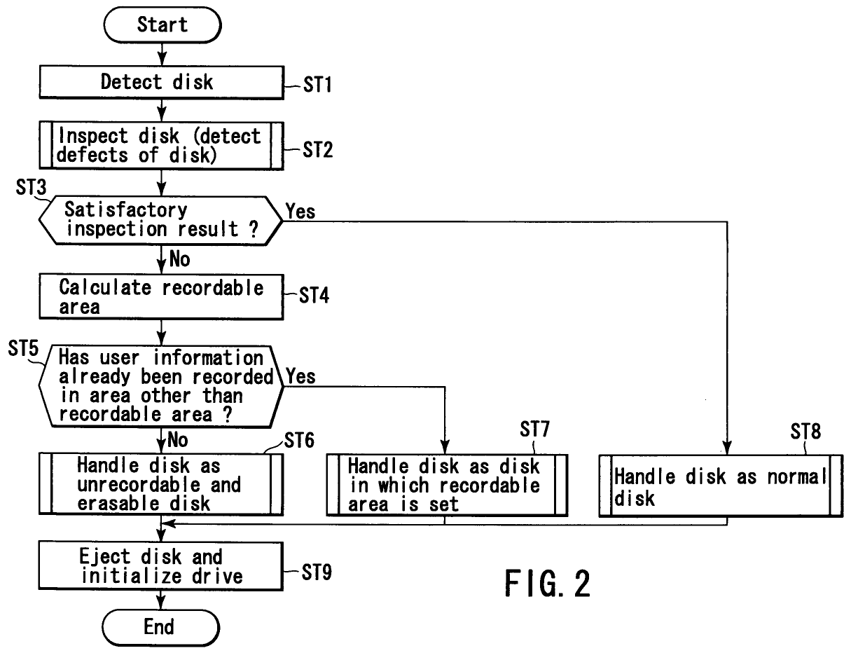

Defect inspection of the optical disk and the recording performance of the optical disk will be described next in more detail. Simultaneously, an optical disk processing method will be described with reference to the flow chart shown in FIG. 2. Defect inspection of the optical disk D such as a CD-R, CD-RW, DVD-R, or DVD-RW will be described.

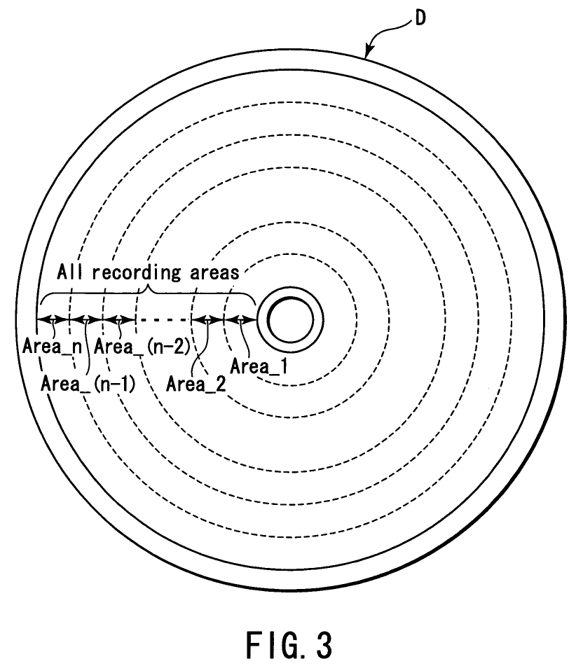

As shown in FIG. 3, the optical disk is divided into n (n is a natural number) areas 1, . . . , n (numbers are assigned on ascending order from the inner peripheral side). That is, the optical disk is divided into n ring-shaped areas having different radial distances. Recording performance A estimated from each defect component obtained by defect inspection of the disk is assigned to each area. The recording performance of an area k (k is a natural number; k<n+1) is represented by Ak.

Defects of a disk include, e.g., warping of the disk (warping component S), waviness of the disk (side-runout component M), eccentricity of the barycenter of the disk (mass eccentricity component H), and eccentricity of the center of the disk (eccentricity component C). The warping component S and side-runout component M can be inspected for each area. The warping component for each area is represented by Sₖ, and the side-runout component for each area is represented by Mₖ. That is, the warping component S and side-runout component M are defect elements that can be detected for every radial distance.

Upon receiving the optical disk D, the optical disk apparatus detects the optical disk D (ST1) and inspects the defect components (ST2). For the warping component S, the tilt of the disk surface is detected in each area, and S₁, S₂, . . . , Sₙ are obtained for the respective areas. The side-runout component M is inspected on the basis of the focus error signal in each area, and M₁, M₂, . . . , Mₙ are obtained for the respective areas. The mass eccentricity component H and eccentricity component C are common to all areas, and H and C are obtained. The recording performance Aₖ of each area is obtained from the defect components obtained in that area. The recording performance of the area k is given by

Aₖ=f(Sₖ, Mₖ, H, C)

where f is defined such that the larger the value Aₖ becomes, the poorer the recording performance becomes.

A threshold value at which sufficient recording performance is obtained is defined as T.

The area k that satisfies Aₖ<T is determined as a recordable area. The area k that does not satisfy Aₖ<T is determined as an unrecordable area.

When all recording areas of the optical disk D satisfy Aₖ<T, the inspection result is satisfactory (YES in ST3). The optical disk D is handled as a normal disk (ST8). That is, all recording areas of the optical disk D are handled as recordable areas.

When not all recording areas of the optical disk D satisfy Aₖ<T, the inspection result is not satisfactory (NO in ST3). Recordable areas are set by the recordable area setting section 26 (ST4). The area k (minimum k) corresponding to the innermost one of the areas that do not satisfy Aₖ<T is defined as k₀. Of all recording areas of the optical disk D, areas 1, 2, . . . , k₀−1 are recordable areas. When information (user information) has already been recorded in an area other than areas 1, 2, . . . , k₀−1 of all recording areas of the optical disk D (YES in ST5), the optical disk D is handled as an unrecordable erasable disk (ST7). When information (user information) has not been recorded in an area other than areas 1, 2, . . . , k₀−1 of all recording areas of the optical disk D (NO in ST5), the capacity of the areas 1, 2, . . . , k₀−1 is handled as the capacity (recordable area) of the disk (ST6).

As has been described above, in the optical disk apparatus and disk processing method according to the embodiment of the present invention, defective areas where no sufficient recording performance can be obtained are detected, and actual recording areas, where information can actually be recorded, of all the recording areas of the optical disk D are set. For an optical disk D such as a CD-R, CD-RW, DVD-R, or DVD-RW, user information is generally recorded from the inner side to the outer side. That is, defective areas, where no sufficient recording performance can be obtained, of al the recording areas of the optical disk are detected, and only areas inside the innermost defective area of the detected defective areas are set as recordable areas. Accordingly, only areas having no defects of the entire recording capacity of the optical disk are used. Even an optical disk having defects can be used without degrading the reliability. The problem that the optical disk wholly becomes unusable due to some serious defects can also be solved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk apparatus comprising:
a defect detection unit configured to detect a defect of a disk;
a setting unit configured to set an actual recording area, where information can actually be recorded, of all recording areas of the disk on the basis of a defect detection result by the defect detection unit; and
a recording unit configured to record user information in the actual recording area set by the setting unit.

2. An apparatus according to claim 1, wherein
the defect detection unit detects the defect for each predetermined area, and
the setting unit obtains recording performance for each predetermined area on the basis of the defect detection result by the defect detection unit, and sets an area which satisfies a predetermined recording performance level in all the recording areas of the disk as the actual recording area where information can actually be recorded.

3. An apparatus according to claim 1, wherein
the defect detection unit detects the defect for each predetermined area corresponding to a radial distance, and
the setting unit obtains recording performance for each predetermined area on the basis of the defect detection result by the defect detection unit, and sets an area inside an innermost one of areas that do not satisfy the predetermined recording performance level in all the recording areas of the disk as the actual recording area where information can actually be recorded.

4. An apparatus according to claim 1, wherein
the defect detection unit detects a first defect, which changes for every radial distance, for each predetermined area corresponding to a radial distance and detects a second defect common to the entire disk, and
the setting unit obtains recording performance for each predetermined area on the basis of the defect detection result by the defect detection unit, and sets an area inside an innermost one of areas that do not satisfy a predetermined recording performance level in all the recording areas of the disk as the actual recording area where information can actually be recorded.

5. An apparatus according to claim 1, wherein when the user information has already been recorded in an area other than the actual recording area of all the recording areas of the disk, the setting unit sets the disk as an unrecordable disk.

6. A disk processing method comprising:
detecting a defect of a disk; and
setting an actual recording area, where information can actually be recorded, of all recording areas of the disk on the basis of a defect detection result.

7. A method according to claim 6, wherein
the defect is detected for each predetermined area, and
recording performance is obtained for each predetermined area on the basis of the defect detection result, and an area that satisfies a predetermined recording performance level in all the recording areas of the disk is set as the actual recording area where information can actually be recorded.

8. A method according to claim 6, wherein
the defect is detected for each predetermined area corresponding to a radial distance, and
recording performance is obtained for each predetermined area on the basis of the defect detection result, and an area inside an innermost one of areas that do not satisfy the predetermined recording performance level in all the recording areas of the disk is set as the actual recording area where information can actually be recorded.

9. A method according to claim 6, wherein
a first defect that changes for every radial distance is detected for each predetermined area corresponding to a radial distance, and a second defect common to the entire disk is detected, and
recording performance is obtained for each predetermined area on the basis of the defect detection result, and an area inside an innermost one of areas that do not satisfy the predetermined recording performance level in all the recording areas of the disk is set as the actual recording area where information can actually be recorded.

10. A method according to claim 6, wherein when user information has already been recorded in an area other than the actual recording area of all the recording areas of the disk, the disk is set as an unrecordable disk.

11. An information recording medium comprising:
a plurality of ring-shaped information recording areas having different radial distances,
wherein on the basis of defect inspection for each information recording area, one or a plurality of predetermined information recording areas of the information recording areas are set as actual recording areas where information can actually be recorded.

12. A medium according to claim 11, wherein recording performance for each information recording area is obtained on the basis of defect inspection for each information recording area, and one or a plurality of information recording areas which satisfy a predetermined recording performance level in the information recording areas are set as actual recording areas where information can actually be recorded.

13. A medium according to claim 11, wherein recording performance for each information recording area is obtained on the basis of defect inspection for each information recording area, and one or a plurality of information recording areas inside an innermost one of information recording areas that do not satisfy a predetermined recording performance level in the information recording areas are set as actual recording areas where information can actually be recorded.

14. A medium according to claim 11, wherein
a first defect caused by the radial distance is detected, and a second defect common to the entire medium is detected on the basis of defect inspection for each information recording area, and
on the basis of a defect detection result, recording performance for each information recording area is obtained, and one or a plurality of information recording areas inside an innermost one of information recording areas that do not satisfy a predetermined recording performance level in the information recording areas are set as actual recording areas where information can actually be recorded.

15. A medium according to claim 11, wherein when user information has already been recorded in one or a plurality of information recording areas which do not correspond to the actual recording areas, the medium is set as an unrecordable medium.
